(19) United States
(12) Patent Application Publication
(10) Pub. No.: US 2024/0336734 A1
(43) Pub. Date: Oct. 10, 2024

(54) METHOD OF SYNTHESIZING A MUCIN AND PRODUCT THEREOF

(71) Applicant: Research Foundation of the City University of New York, New York, NY (US)

(72) Inventors: Adam Braunschweig, New York, NY (US); Manuel Lema, Woodhaven, NY (US); Antonio Cerullo, New York, NY (US); Ilse Nava-Medina, New York, NY (US)

(21) Appl. No.: 18/681,351

(22) PCT Filed: Aug. 4, 2022
(86) PCT No.: PCT/US2022/039409

§ 371 Date: Feb. 5, 2024

Related U.S. Application Data
(60) Provisional application No. 63/304,223, filed on Jan. 28, 2022.
(60) Provisional application No. 63/229,321, filed on Aug. 4, 2021.

(51) Int. Cl. C08G 69/10; C08G 69/48; C08J 3/075; C08J 3/24

(52) U.S. Cl. CPC C08G 69/10; C08G 69/48; C08J 3/075; C08J 3/24

(57) ABSTRACT

A synthetic mucin formed by performing a ring-opening polymerization of carbohydrate N-carboxyanhydride (NCA) followed by deprotection of at least one protecting group from the carbohydrate. The resulting synthetic mucin can be produced in large quantities and obviates many of the problems associated with using natural mucins obtained from biological sources.

### CROSS-REFERENCE TO RELATED APPLICATIONS

This application claims priority to and is a non-provisional of U.S. Patent Applications 63/229,321 (filed Aug. 4, 2021) and 63/304,223 (filed Jan. 28, 2022) the entirety of which are incorporated herein by reference.

### STATEMENT OF FEDERALLY SPONSORED RESEARCH OR DEVELOPMENT

This invention was made with government support under grant numbers FA9550-19-1-0220 awarded by Air Force Office of Scientific Research. The government has certain rights in the invention.

### BACKGROUND OF THE INVENTION

Secreted mucus hydrogels have diverse functions in nature, including as adhesives, lubricants, barriers, filters, and mineralizing and hydrating agents. Yet, there are several challenges precluding their wider adoption in materials, biotechnology, and medical applications. For example, the collection of natural mucus, such as porcine gastric mucins, can exhibit high levels of batch-to-batch variability because of pH-induced and bacterial degradation. Additionally, natural mucus can be impractical or potentially dangerous to collect. Furthermore, the study of natural mucins requires challenging purification because mucus is a heterogeneous material containing proteins, salts, and carbohydrates; adequately characterizing even a single natural mucin requires isolating a single protein from the bulk, crosslinked hydrogels, and independently determining the polypeptide and glycan structures, and the molecular weights of the polydisperse, stochastically structured glycoproteins. Currently, mucin is commercially obtained from biological sources (e.g. snails, pigs, cows, etc.). However, these biological sources are not sustainably scalable for industrial demand. Furthermore, there is a high degree of batch-to-batch variability when mucin is obtained from such biological sources. Contamination of the mucin (e.g. parasites) and poor shelf-stability are also significant drawbacks. Attempts have therefore been made to produce mucins synthetically.

Three main strategies to construct synthetic mucins are (1) solid-phase syntheses of glycosylated amino acids, (2) post-polymerization glycosylation or (3) solution polymerization from glycomonomers. However, each of these strategies has significant disadvantages that has, to date, prevented widespread commercial use of synthetic mucins. Solid-phase synthesis provides absolute sequence control of a peptide backbone but is limited to short peptide chains and is only suitable for small-scale synthesis. Post-polymerization glycosylation is more scalable and provides access to higher molecular weights but the backbones are not peptide backbones and there is no sequence control. Solution polymerization is also scalable and provides access to higher molecular weights with a diverse range of backbones. However, solution polymerization requires the formation of relative complex monomers. An improved method of producing synthetic mucins is therefore desired.

The technical problem to be solved is the art's current inability to provide inexpensive, scalable production of synthetic mucins. A further technical problem to be solved in the art's inability to provide synthetic mucins with customizable properties such that synthetic mucins can mimic the properties of natural mucins.

The discussion above is merely provided for general background information and is not intended to be used as an aid in determining the scope of the claimed subject matter.

### SUMMARY

This disclosure provides a synthetic mucin formed by performing a ring-opening polymerization of carbohydrate N-carboxyanhydride (NCA) followed by deprotection of at least one protecting group from the carbohydrate. The resulting synthetic mucin can be produced in large quantities and obviates many of the problems associated with using natural mucins obtained from biological sources.

In a first embodiment, a composition of matter is provided. The composition of matter comprising: a polymer produced from (1) performing a ring-opening polymerization of a mixture comprising: a solvent; a first monomer with a structure of:

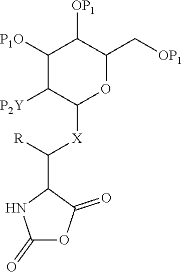

wherein P₁ and P₂ are protecting groups, X is S or O, Y is O or NH and R is selected from a group consisting of H and CH₃; and then (2) performing a deprotection reaction wherein at least one P₁ is removed.

In a second embodiment, a composition of matter is provided. The composition of matter comprising a polymer produced from sequentially (1) performing a ring-opening polymerization of a mixture comprising: a solvent; a first monomer with a structure of:

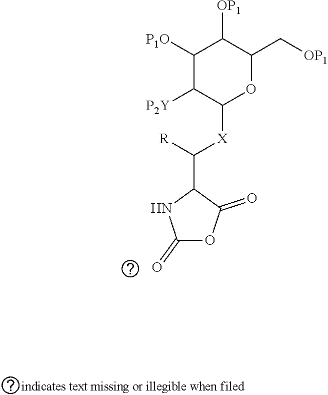

a second monomer with a structure of:

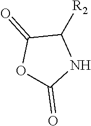

wherein P₁ and P₂ are protecting groups, X is S or O, Y is O or NH and R is selected from a group consisting of H and CH₃ and R₂ is a protected CH₂SH; (2) performing at least one deprotection reaction wherein at least one P₁ is removed and wherein the protected CH₂SH is deprotected to produce thiols; and (3) oxidizing the thiols to crosslink the polymer, thereby producing a hydrogel.

In a third embodiment, a method for synthesizing a composition of matter is provided. The method comprising sequential steps of: performing a ring-opening polymerization of a mixture comprising: a solvent; a first monomer with a structure of:

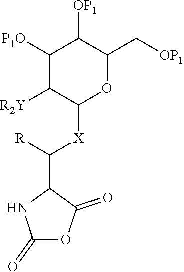

wherein P₁ and P₂ are protecting groups, X is S or O, Y is O or NH and R is selected from a group consisting of H and CH₃; performing a deprotection reaction wherein at least one P₁ is removed.

In a fourth embodiment, a composition of matter is provided. The composition of matter having a structure of:

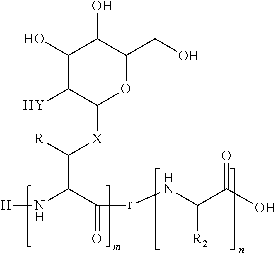

wherein m and n are independently selected integers between 1 and 150, X is S or O, Y is O or NH and R is selected from a group consisting of H and CH₃, and R₂ is selected from a group consisting of CH(CH₃)OH, CH₂OH, CH₃, CH₂SH and isobutyl and r denotes random copolymerization.

In a fifth embodiment, a composition of matter is provided. The composition of matter has a structure of:

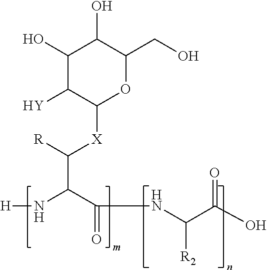

wherein m and n are independently selected integers between 1 and 150, X is S or O, Y is O or NH and R is selected from a group consisting of H and CH₃, and R₂ is selected from a group consisting of CH(CH₃)OH, CH₂OH, CH₃, CH₂SH and isobutyl.

This brief description of the invention is intended only to provide a brief overview of subject matter disclosed herein according to one or more illustrative embodiments and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts two synthetic schemes for producing synthetic mucins.

FIG. 2 illustrates a retrosynthetic analysis of a carbohydrate N-carboxyanhydride.

FIG. 3 is an example of a synthetic method to produce a carbohydrate N-carboxyanhydride.

FIG. 4A is a retrosynthetic analysis of a functionalized carbohydrate useful in producing the carbohydrate N-carboxyanhydride.

FIG. 4B is one example of a synthesis of a carbohydrate N-carboxyanhydride.

FIG. 5 is another example of a synthesis of a carbohydrate N-carboxyanhydride.

FIG. 6A depicts a ring-opening polymerization and deprotection of a carbohydrate N-carboxyanhydride to form a synthetic mucin.

FIG. 6B is one example of a ring-opening polymerization and deprotection of a carbohydrate N-carboxyanhydride to form a synthetic mucin.

FIG. 7A depicts a table showing control of the ring-opening polymerization by altering reaction conditions.

FIG. 7B depicts another table showing control of the ring-opening polymerization by altering reaction conditions.

FIG. 8A shows the results of lubricity tests on a particular synthetic mucin.

FIG. 8B, FIG. 8C and FIG. 8D show lubricity is maintained after subjecting the synthetic mucin to shear forces.

FIG. 8E shows the results of lubricity tests on a particular synthetic mucin as a function of calcium ion concentration.

FIG. 9 is a table showing quantification of material properties of a synthetic mucin at various concentrations of calcium ions.

FIG. 10 depicts a ring-opening polymerization and deprotection of a carbohydrate N-carboxyanhydride in the presence of a second monomer to form a synthetic mucin.

FIG. 11 depicts examples of various carbohydrate N-carboxyanhydrides and second monomers.

FIG. 12 is one example of a ring-opening polymerization and deprotection of a carbohydrate N-carboxyanhydride in the presence of a second monomer to form a synthetic mucin.

FIG. 13 depicts a table showing control of the ring-opening polymerization by altering reaction conditions.

FIG. 14 is a table showing control of the resulting copolymer by altering ratios of the N-carboxyanhydride and the second monomer.

FIG. 15A and FIG. 15B are graphs of storage modulus and viscosity as a function of shear rate of a particular synthetic mucin.

FIG. 16 depicts a copolymerization method that uses at least one N-carboxyanhydride and at least two second monomers.

FIG. 17 depicts a copolymerization method that uses at least two N-carboxyanhydrides and at least one second monomer.

FIG. 18 depicts a polymerization method for forming a block-copolymer.

FIG. 19A and FIG. 19B are spectral data showing collagen and the synthetic mucins interact when mixed.

FIG. 20A is a UV-Vis spectra showing collagen and the synthetic mucins interact when mixed.

FIG. 20B is another UV-Vis spectra showing collagen and the synthetic mucins interact when mixed.

FIG. 21A and FIG. 21B are fluorescent spectra showing collagen and the synthetic mucins interact when mixed.

FIG. 22A, FIG. 22B and FIG. 22C are surface images of mucin, collagen and a mixture of mucin and collagen respectively, as determined by atomic force spectroscopy.

FIG. 23 is a UV-Vis spectra showing cellulose and the synthetic mucins interact when mixed.

### DETAILED DESCRIPTION OF THE INVENTION

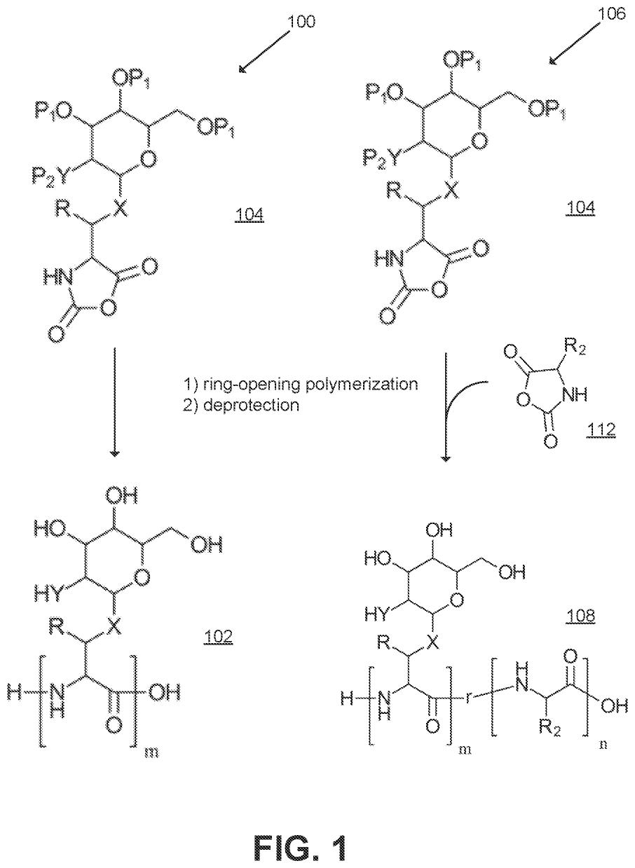

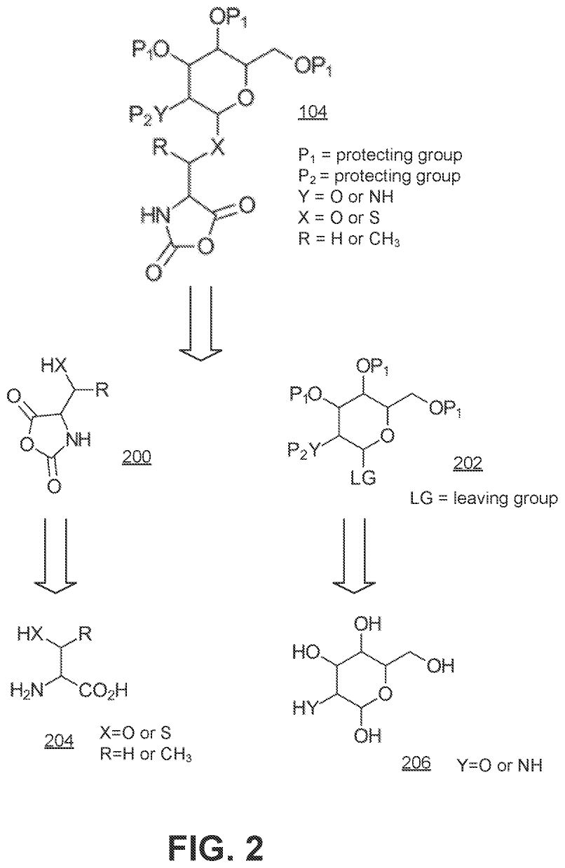

FIG. 1 depicts a method 100 of generating a synthetic mucin 102 by subjecting a carbohydrate N-carboxyanhydride, NCA 104, to sequential steps of ring-opening polymerization and deprotection (removal of protecting groups P1 and P2). In such an embodiment, the carbohydrate NCA 104 functions as a first monomer such that the synthetic mucin 102 is a homopolymer. FIG. 2 also depicts a method 106 of generating a synthetic mucin 108 by subjecting the carbohydrate NCA 104 to ring-opening polymerization in the presence of at least one second NCA 112. The resulting composition is then deprotected. The carbohydrate NCA 104 functions as a first monomer and the second NCA 112 functions as a second monomer such that the synthetic mucin 108 is a block-random copolymer.

As discussed in detail elsewhere in this specification, the resulting synthetic mucins have customizable properties that have uses in a wide range of commercial products including cosmetics, dermatology, electrically conductive coatings, drug delivery, coating of medical implants, articular lubrication, adhesives and would healing.

FIG. 2 schematically depicts a retrosynthetic analysis of carbohydrate NCA 104. In the embodiment of FIG. 2, P₁ and P₂ are protecting groups that may be the same or different. Examples of suitable protecting groups include acetates, phenyl, benzyl, benzoyl, allyl, trimethylsilyl, N,N-dimethylaminopyridine, 3,5-O-di-tert-butylsilane, methyl, ethyl, tert-butyldimethylsilyl, p-methoxybenzyl, butyl, t-butylsimethylsilyl, tetrabutylammonium fluoride, triphenylmethyl, p-toluenesulfonyl, t-butyldimethylsilyl, t-butyldiphenylsilyl, 9-fluronyloxycarbonyl, benzyloxycarbonyl, p-bromo, p-chlorobenzyl, p-nitrobenzyl, o-nitrobenzyl, s-glycoside, methoxyacetyl, dichloroacetyl, 2,2,2-trichloroethoxycarbonyl, methoxymethyl, methanesulfonyl, N-bromosuccinimide, trifluoromethanesulfonyl, etc. In FIG. 2, Y may be O or NH, X may be O or S and R is H or CH 3.

Retrosynthetically, carbohydrate NCA 104 may be constructed from NCA 200 which, in turn, is obtainable from amino acid 204. Functionalized carbohydrate 202 may be obtained from carbohydrate 206. In functionalized carbohydrate 202 the leaving group (LG) may be any suitable leaving group including, but not limited to, halides (e.g. bromine chloride, iodine, fluorine), acetyl, methyl, hydroxyl, thioglycosil, trichloroacetamide, etc.

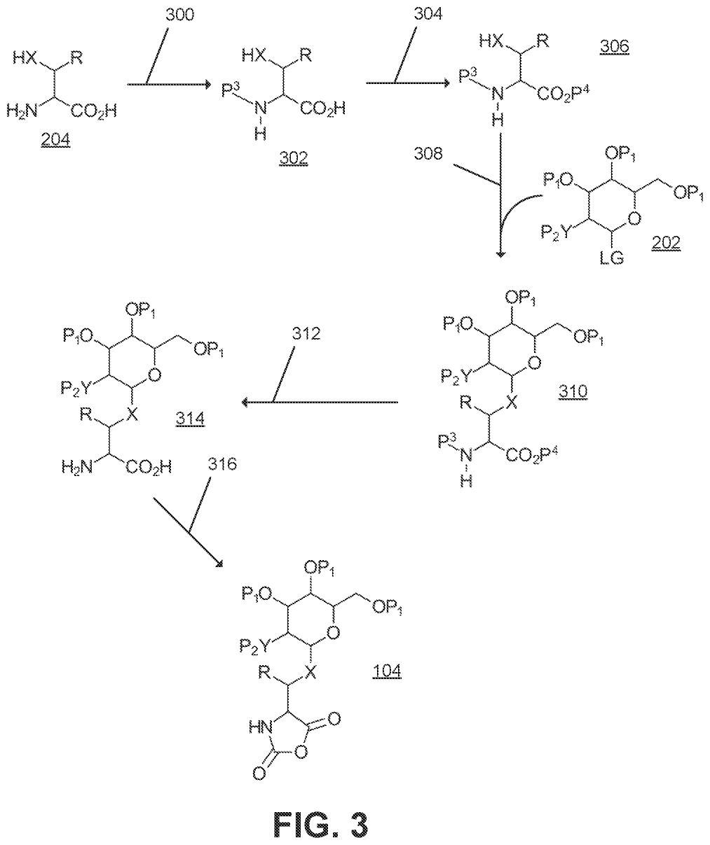

FIG. 3 depicts a generalized synthetic scheme in the forward direction. In Step 300, the amino acid 204 is N-protected with a protecting group (P³) to produce mono-protected compound 302. In step 304 the monoprotected compound 302 is carboxyl-protected with a protecting group (P⁴) to produce di-protected compound 306. In step 308 the di-protected compound 306 is coupled with functionalized carbohydrate 202 such that the leaving group (LG) is displaced, thereby forming compound 310. In step 312, the protecting groups (P³ and P⁴) on the amino acid are removed to produce compound 314. Compound 314 is then subjected to cyclization conditions to produce the carbohydrate NCA 104.

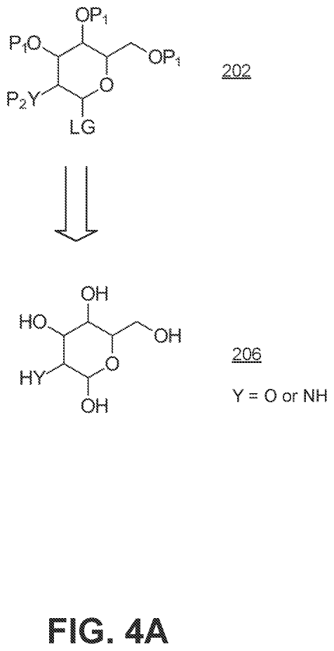

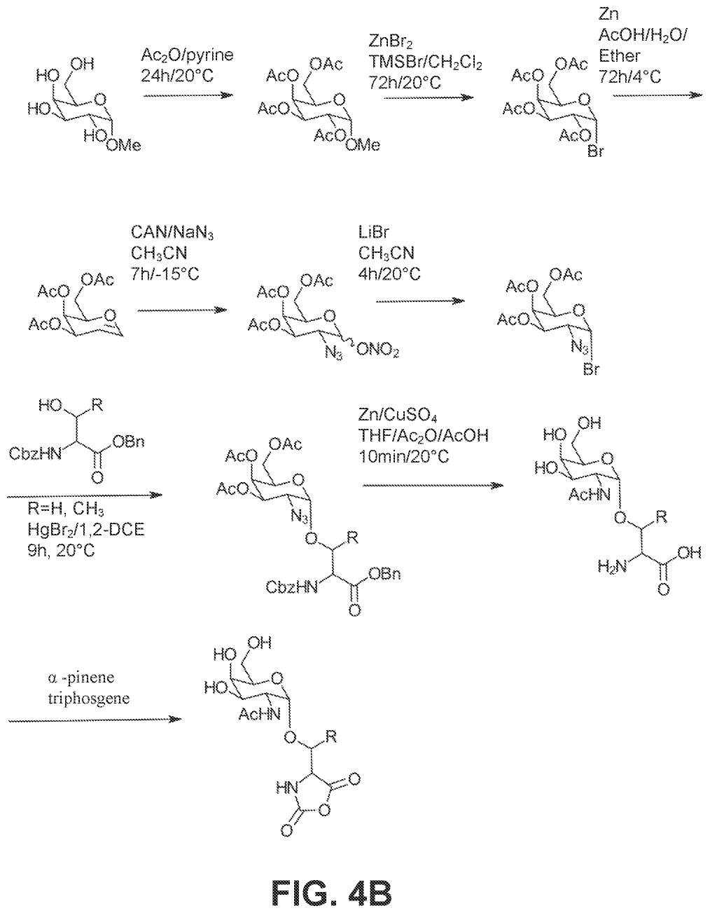

FIG. 4A depicts a retrosynthetic analysis of the functionalized carbohydrate 202 in further detail. Several carbohydrates 202 are commercially available (e.g. Y═O, P₁═P₂═Ac, LG=Br) and synthetic routes for obtaining others are known. The functionalized carbohydrate 202 is generally derived from carbohydrate 206. Suitable carbohydrates (wherein Y═O) include monosaccharides such as galactose, glucose, allose, altrose, mannose, gulose, idose and talose. The corresponding nitrogen analogs (wherein Y═NH and P₂=protecting group) are also known. See, for example, FIG. 4B.

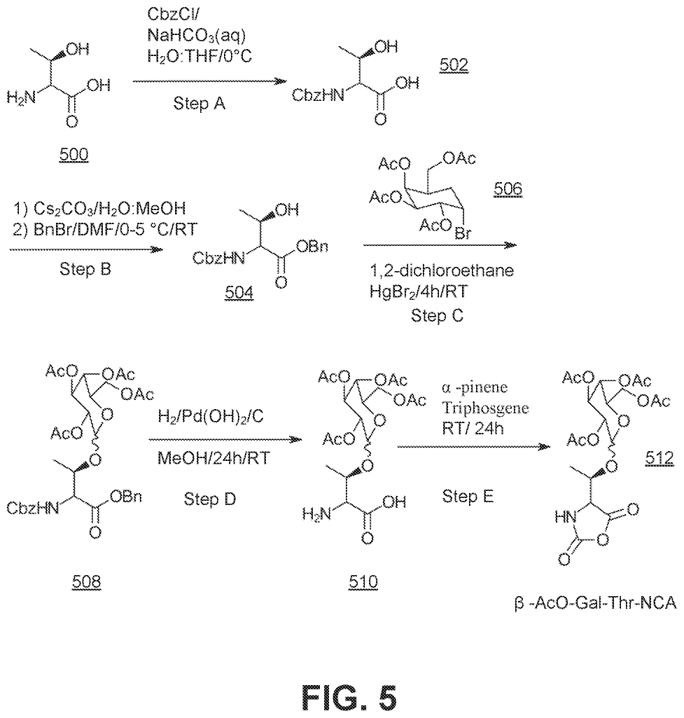

By way of illustration, and not limitation, FIG. 5 presents one example of a synthesis of an NCA 512. Amino acid 500 (e.g. threonine) is N-protected with a protecting group (e.g. Cbz) to produce mono-protected compound 502. The monoprotected compound 502 is carboxyl-protected as the benzyl ether to produce di-protected compound 504. The di-protected compound 504 is coupled with functionalized carbohydrate 506 (e.g. functionalized galactose) such that the leaving group (e.g. Br) is displaced, thereby forming compound 508. The protecting groups (Cbz and Bn) on the amino acid are removed to produce compound 510. Compound 510 is then subjected to cyclization conditions to produce the NCA 512. In the embodiment of FIG. 5, the resulting NCA 512 is β—AcO-Gal-Thr-NCA.

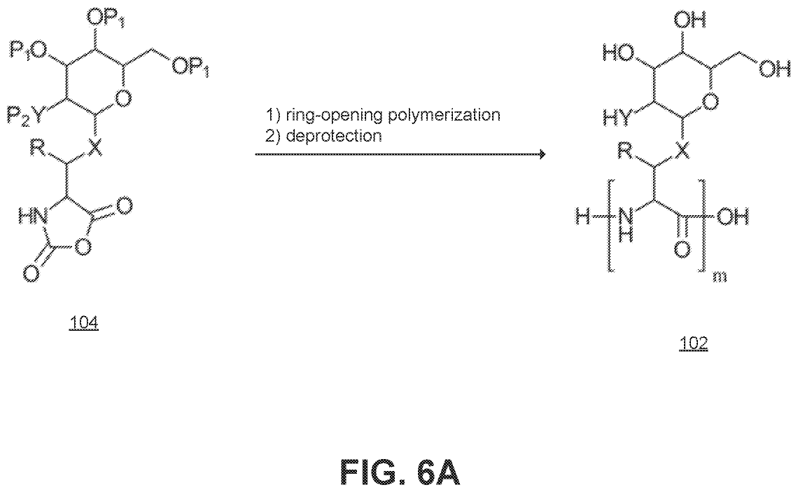

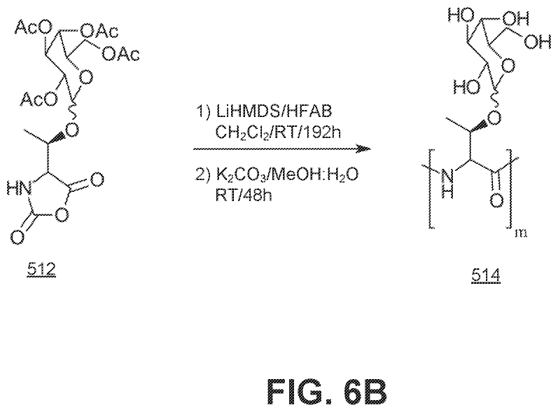

FIG. 6A depicts the carbohydrate NCA 104 undergoing a ring-opening polymerization reaction followed by a deprotection (removing P₁ and P₂) to produce the synthetic mucin 102. In the embodiment of FIG. 6A, m is an integer that is at least 1 and is less than or equal to 150. In another embodiment, m is at least 5 and less than or equal to 50. In yet another embodiment, m is at least 10 and is less than or equal to 40. A variety of conditions can be utilized to effect these steps. Examples of suitable solvents include organic solvents such as tetrahydrofuran (THF), dichloromethane (DCM), chloroform, dimethylformamide (DMF), and the like. For example, the ring-opening polymerization reaction may be performed using a base such as a hexamethyldisilazide base. In some embodiments, a catalyst (e.g. 1,3-bis(2-hydroxyhexafluoroisopropyl) benzene (HFAB), diethylethanolamine (DMEA), etc.) may also be used. In still other embodiments, a metal catalyst (e.g. bipy(Ni(COD) or depeNi(COD), Co(PMe₃)₄ and Co(bipy)₂) is used.

The deprotection step can likewise be performed under a variety of conditions. In one embodiment, all of the P₁ protecting groups are removed. In another embodiment, at least one, but fewer than all, P₁ protecting group is selectively removed. Selective deprotection of such carbohydrates is known to those skilled in the art.

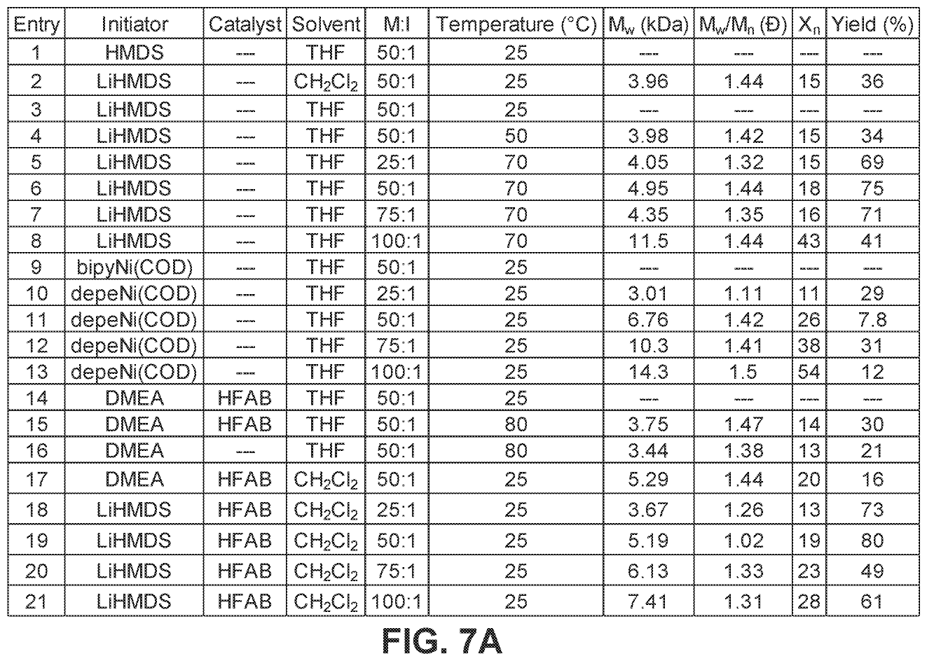

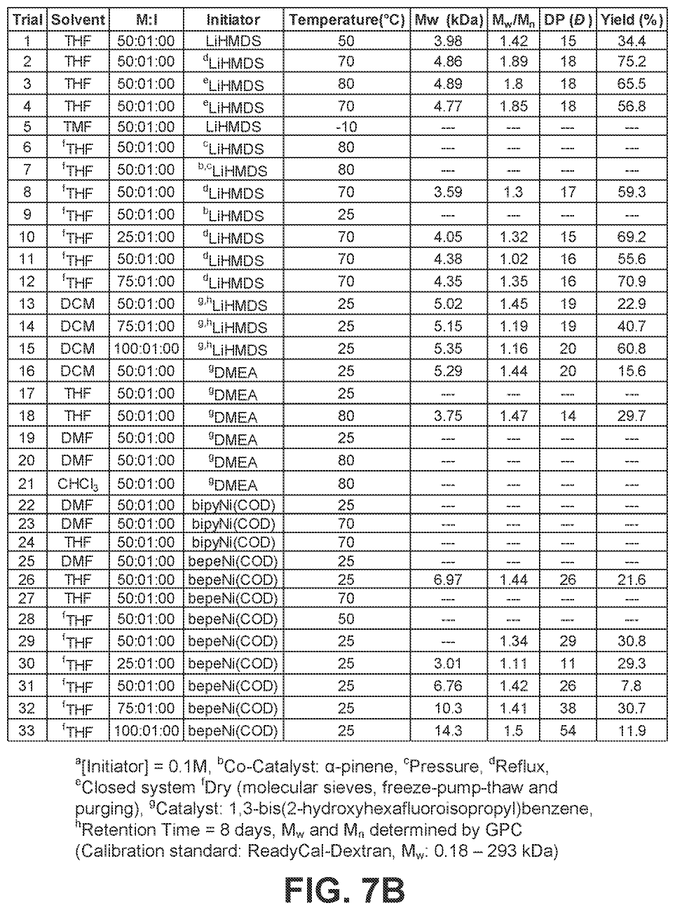

By way of illustration, and not limitation, FIG. 6B presents one example of a synthesis of a synthetic mucin 514. In the embodiment of FIG. 6B, NCA 512 is β-AcO-Gal-Thr-NCA. NCA 512 was treated with LiHMDS/HFAB in methylene chloride at room temperature for 192 hours. These conditions performed the ring-opening polymerization. Subsequently, the protecting groups (P₁═P₂═Ac) were removed by treatment with K₂CO₃ in methanol:water at room temperature for 48 hours to produce the synthetic mucin 514. As shown in FIG. 7A, the final composition of the synthetic mucin 514 is controllable by adjusting the reaction conditions of the ring-opening polymerization.

FIG. 7A depicts a table listing the results of ring-opening polymerization and deprotection under a variety of conditions. The initiator (0.1M) was used with different molar ratios of monomer:initiator (M:I). The solvent was dried by molecular sieves, freeze-pump-thawing, and purging with Ar. The M_{w}, Mₙ and D were determined on the deprotected polymers (GPC, calibration standard: READYCAL™-Dextran, M_{w}: 0.18-298 kDa, 0.05M LiBr in 1:1 DMF:DMSO, 0.25 mL/min, 60° C.). In the table of FIG. 7A, molecular weights were all between 1 kDa to 20 kDa. In one embodiment, the molecular weight is between 1 kDa and 10 kDa. In another embodiment, the molecular weight is between 3 kDa and 10 kDa. The number of monomeric repeats of the homopolymer (Xₘ) was least 1 and less than or equal to 150. In another embodiment, Xₘ is at least 10 and less than 100. In yet another embodiment, Xₘ is at least 10 and less than 30. FIG. 7B shows the results of still further ring-opening polymerization conditions. By controlling reaction conditions, the properties of the resulting synthetic mucin can be controlled.

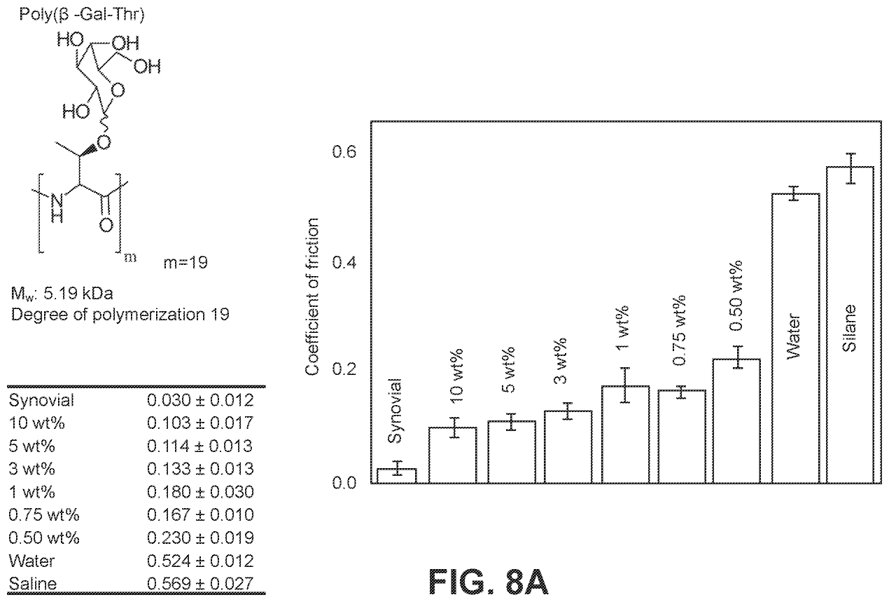

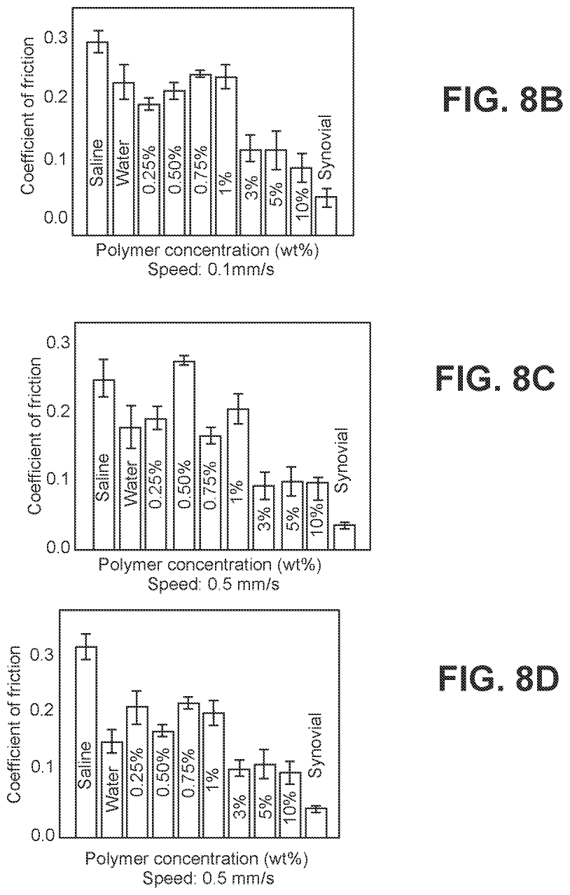

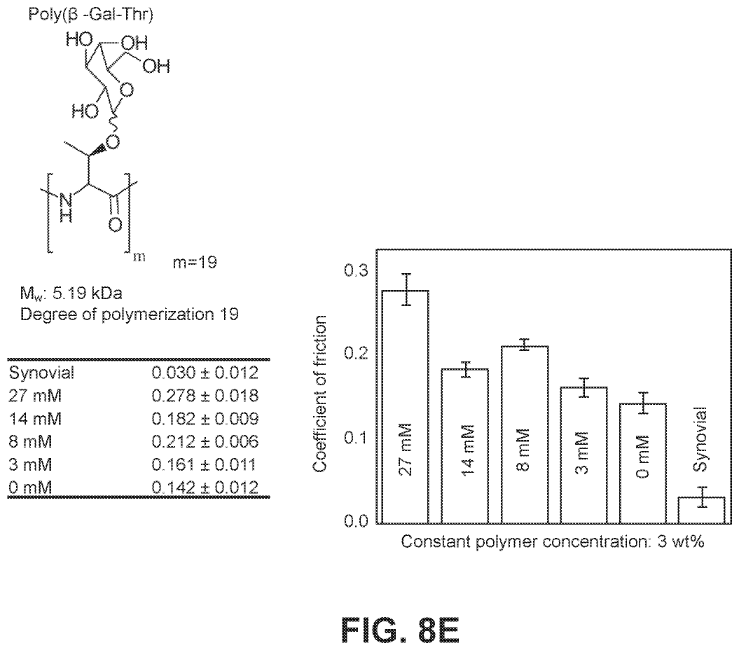

FIG. 8A shows the lubricity properties of solutions of poly(#-Gal-Thr) wherein m=19 and M_{w} is 5.19 kDa. Deionized water, human synovial fluid and a silane solution were used as controls. Solutions of the poly(P-Gal-Thr) were prepared in deionized water at various concentrations, ranging from 0.50 wt % to 10 wt %. Lubricity of the resulting solutions was evaluated by measuring the coefficient of friction (microtribometer with optical capabilities, PDMS sylgard 184 tip (2 mm radius), probe sliding on fused silica counterface, 10 cycles, Normal force: 3 mN, 0.1 V (mm/s)). The resulting solutions showed significant lubricity.

FIG. 8B, FIG. 8C and FIG. 8D demonstrate the lubricity of solutions of poly(P-Gal-Thr) (m=19 and M_{w} is 5.19 kDa) is preserved under a variety of shear forces. Furthermore, the poly(β-Gal-Thr) was found to be shelf-stable for at least six months (determined by NMR) when stored as a solid. This improved stability represents a significant improvement over natural mucins.

FIG. 8E shows the lubricity properties of a 3 wt % solution of the poly(β-Gal-Thr) (m=19 and M_{w} is 5.19 kDa) at various concentrations of calcium ions (ranging from 0 mM to 27 mM). Without wishing to be bound to any particular theory, the calcium concentration may be impacting hydrogel formation which, in turn, impacts the lubricity.

In one embodiment synthetic mucus hydrogels were produced by dissolving a purified glycosylated polymers (e.g. the purified poly(β-Gal-Thr)) into water, and varying polymer concentration and calcium chloride concentration at pH=2. Generally, natural mucuses form hydrogels at low pH; therefore, the formation of mucus-inspired hydrogels gels can potentially be triggered by acidic conditions. In addition, calcium, sodium, magnesium, beryllium, barium, magnesium, iron, strontium and lanthanide ions concentration plays a role in the formation of mucus hydrogels; specifically, calcium ion can alter the material property or function that the mucus has by forming bridges between glycans in adjacent polymer chains. The nanoscale morphology of the hydrogel-forming suspensions was observed with Atomic Force Microscopy (AFM), and the simultaneous increase of the poly(Gal-Thr) concentration and calcium ion concentrations resulted in more organized, gel-like structures.

Other suitable methods may be used for forming hydrogels. For example, a 10 wt % solution of poly(β-Gal-Thr) may be prepared. A solution of an oxidant (e.g. hydrogen peroxide or an oxidizing enzyme) is added in equimolar amount with respect to the thiol residues. For example, hydrogen peroxide with 10 mol % KI may be used. The resulting solution is sonicated for 1 h to produce a 5 wt % mucin hydrogel.

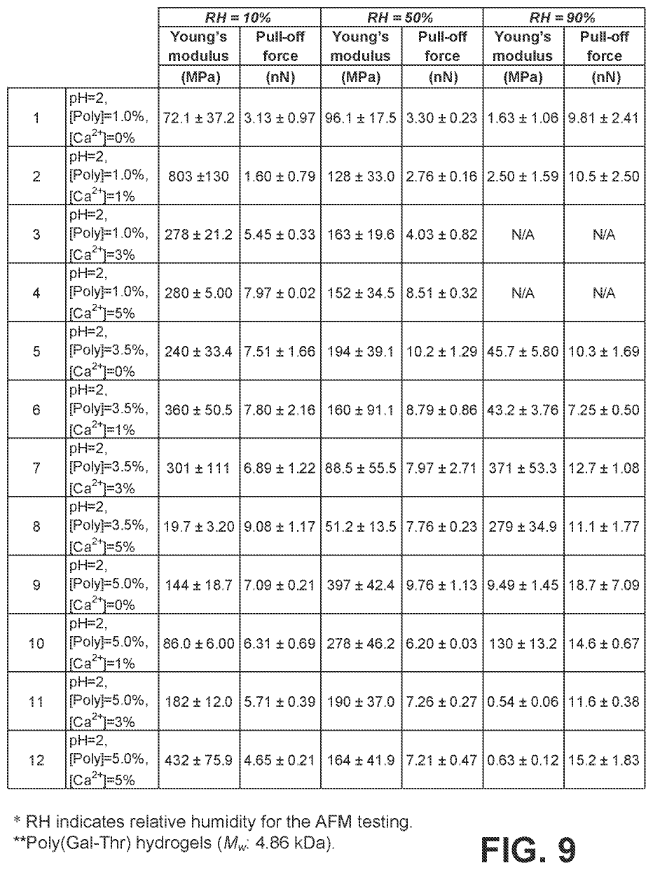

Referring to FIG. 9, the mechanical properties of the mucus-inspired hydrogels (poly(β-Gal-Thr, Mw 4.86 kDa) were tested by atomic force microscope (AFM). AFM measurements were performed at room temperature (25° C.) on an AFM microscope (Bruker multimode 8 model) using the ramp nanoindentation mode. The ramp nanoindentation mode employs a hydrophilic cantilever tip (8.0 nm radius) with a spring constant of 0.14-0.16 N/m, and reflection sensitivity of 39-41 nm/V. The mechanical properties of the mucus-inspired hydrogels were derived from the retraction and approach curves. The retraction curve was analyzed to obtain the Young's modulus (E) by fitting the slope of the curve to a Hertzian model. Similarly, the work of adhesion Wₐ was calculated from the area in between the approach and retraction curves. Therefore, data from three different locations was obtained on a given sample and each location was tested by three indentations (n=9). The three measurements with the best fitting (R²≥0.9) were averaged and the E and Wₐ values are reported in FIG. 9. FIG. 9 depicts the influence of ion concentration, polymer concentration, and relative humidity (RH) on the hydrogel mechanical properties. This demonstrates the material properties of the resulting hydrogels formed from synthetic mucin can be customized by controlling metal ion concentration.

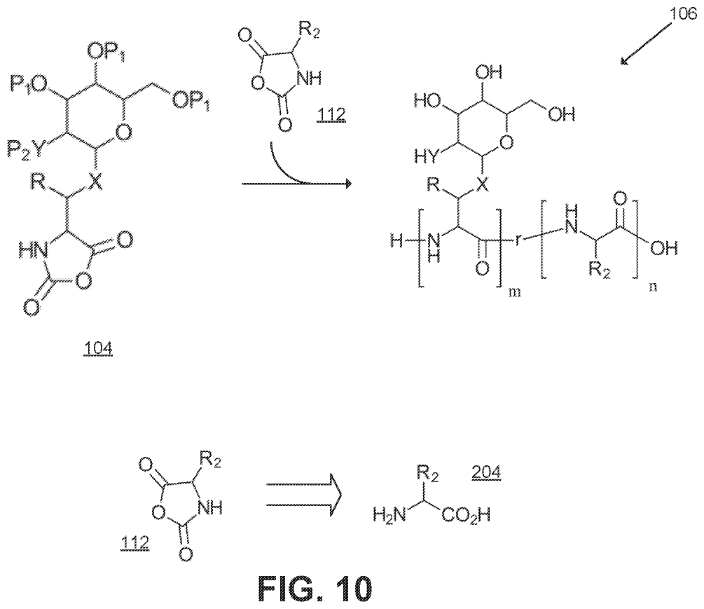

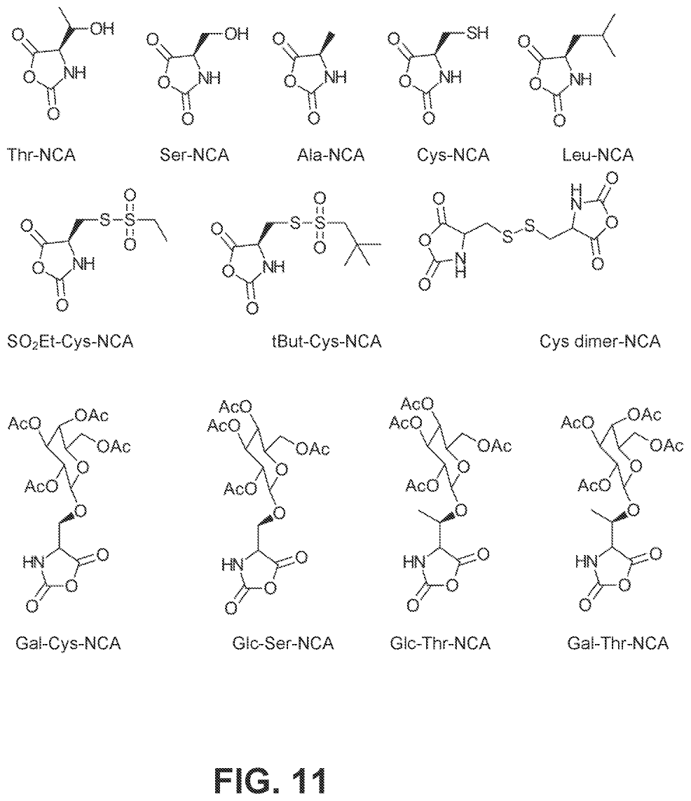

Referring to FIG. 10, the method 106 for generating the synthetic mucin 108 is shown. The carbohydrate NCA 104 is subjected to ring-opening polymerization in the presence of at least one second NCA 112. The resulting composition is then deprotected. The carbohydrate NCA 104 functions as a first monomer and the second NCA 112 functions as a second monomer such that the synthetic mucin 108 is a block-random copolymer. The r in FIG. 10 denotes random copolymerization. The second NCA 112 is derived from an amino acid 204 using cyclization chemistry (e.g. triphosgene treatment) as discussed elsewhere in this specification. In this fashion, a wide variety of second NCAs 112 are accessible which, in turn, provide a range of R₂ groups. FIG. 11 provides a non-exhaustive library of carbohydrate NCAs 104 and second NCAs 112. R₂ may be, for example, CH(CH₃)OH, CH₂OH, CH₃, isobutyl, CH₂SH, benzyl, 4-methoxybenzyl, benzyloxymethyl, 9-fluorenylmethyl-oxycarbonyl, trityl, diphenylmethyl, tetrahydropyranyl, 3,4-dimethylbenzyl, methylbenzyl, 1-adamantyl, 2,4,6-trimethyoxybenzyl, pseudoprolines, 4-methyltrityl, 4-methoxytrityl, 9H-xanthen-9-yl, 4-methyoxybenzyloxymethyl, 2,6-dimethoxybenzyl, 4-methoxy-2-methylbenzyl, acetamidomethyl, 5-dibenzosuberyl, benzamidomethyl, dimethylphosphinothioyl, trimethyl-acetamidomethyl, 9-fluorenylmethyl, phenyl-acteamidomethyl, a protected cystine, CH₂SSO₂CH₂CH₃, CH₂SSCH₂(t-butyl), a protected CH₂SH, a protected glucose (i.e. alcohol-protected), a protected galactose (i.e. alcohol-protected) or CH₂SSCH₂—NCA. The carbohydrates may, for example, be protected as corresponding acetates.

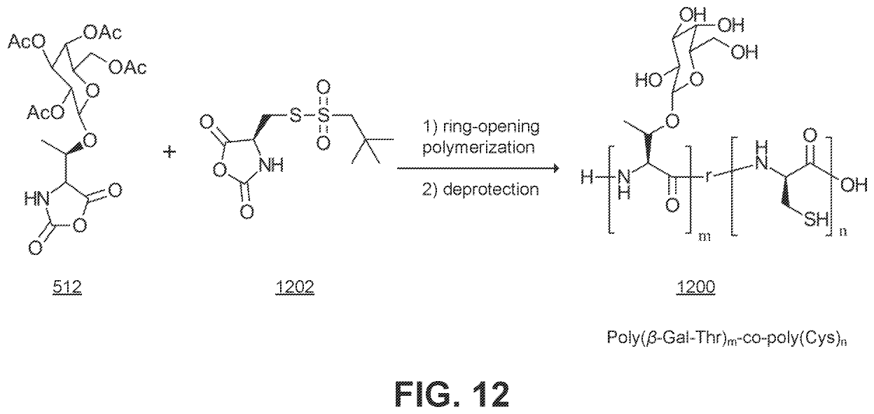

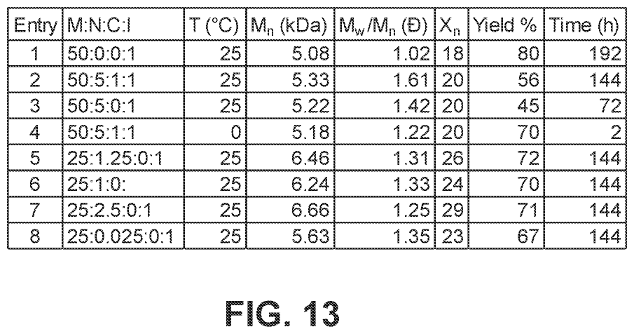

By way of illustration, and not limitation, FIG. 12 presents one example of a synthesis of a block-random synthetic mucin 1200. The NCA 512 was copolymerized with second NCA 1202 (a protected threonine derivative, tBut-Cys-NCA) to produce the block-random synthetic mucin 1200.

FIG. 12 depicts a table listing the results of ring-opening polymerization and deprotection under a variety of conditions that utilize the specific monomers shown in FIG. 12. In the embodiment of FIG. 12, m is an integer that is at least 1 and is less than or equal to 150. In another embodiment, m is at least 5 and less than or equal to 50. In yet another embodiment, m is at least 10 and is less than or equal to 40. Likewise, n is an integer that is at least 1 and is less than or equal to 150. In another embodiment, n is at least 1 and less than or equal to 50. In yet another embodiment, n is at least 1 and is less than or equal to 10. In yet another embodiment, n is at least 1 and is less than or equal to 10. In one embodiment, m is greater than n. In one such embodiment, the ratio of m:n is between 3:1 to 25:1.

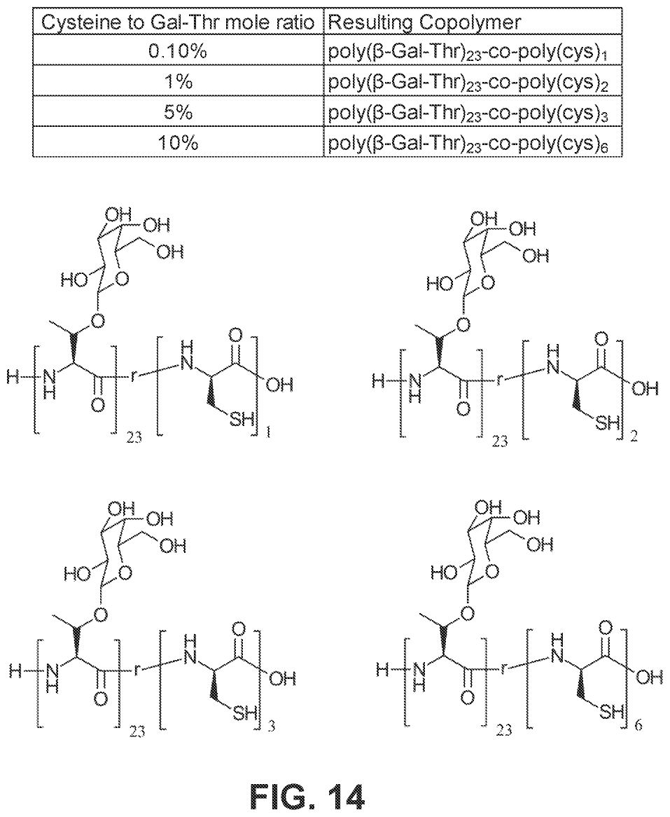

As shown in FIG. 12, the final composition of the block-random synthetic mucin 1200 is controllable by adjusting the reaction conditions of the ring-opening polymerization. In the table of FIG. 12, molecular weights were all between 1 kDa to 20 kDa. In another embodiment, the molecular weight is between 1 kDa and 10 kDa. In yet another embodiment, the molecular weight is between 3 kDa and 10 kDa. As shown in FIG. 14, the cystine content can be varied to control the values of m and n.

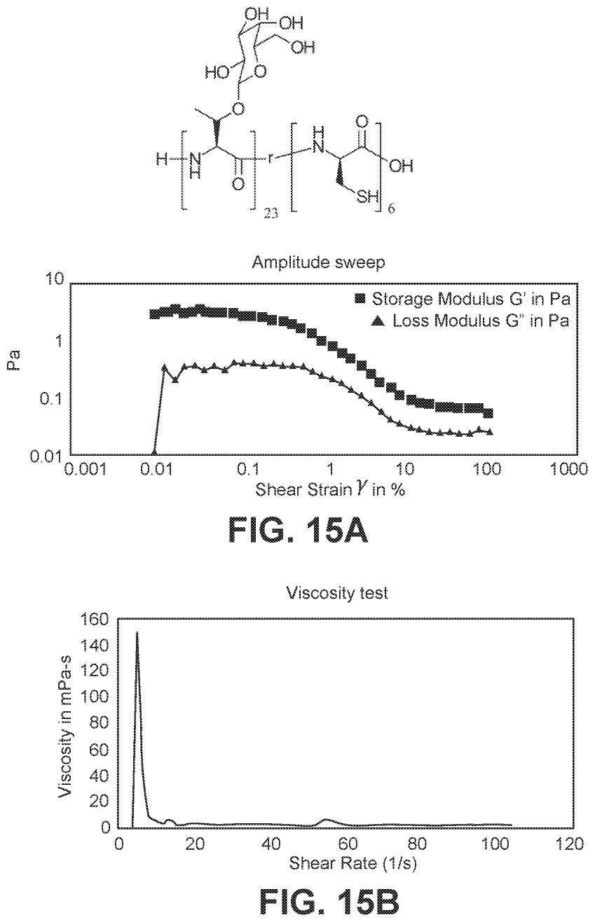

Referring to FIG. 15A and FIG. 15B, the inclusion of cystine permits crosslinking to occur which, in turn, alters the properties of the resulting hydrogel. FIG. 15A is an amplitude sweep of 5 wt % poly(Gal-Thr)₂₃-co-Cys)e showing storage modulus (G′) and loss modulus (G″) as a function of shear strain. FIG. 15B show the viscosity as a function of shear rate. These results show crosslinking has occurred and a hydrogel has been formed.

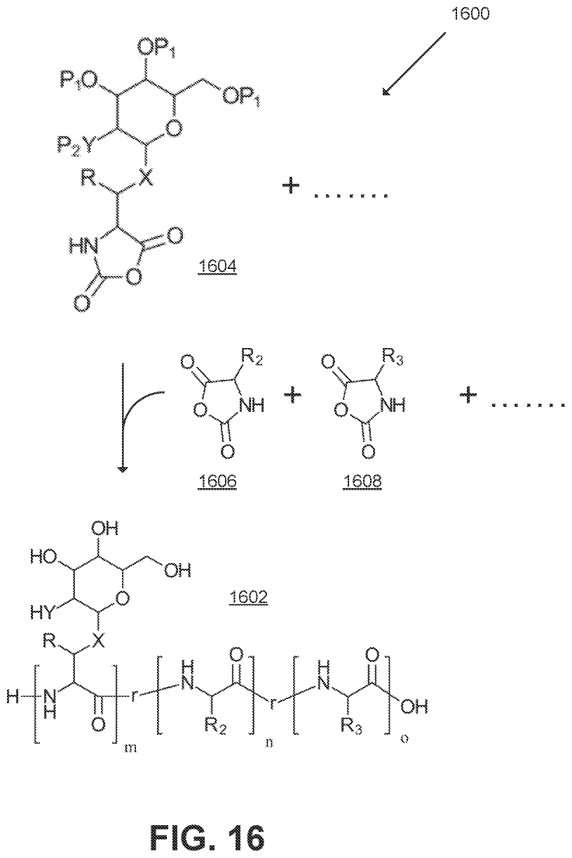

FIG. 16 depicts a method 1600 for forming a block-random copolymer 1602. In method 1600, at least one carbohydrate NCA 1604 is copolymerized with at least two different second NCAs 1606, 1608. In one embodiment, two different second NCAs are used. In another embodiment, three different second NCAs are used. In yet another embodiment, four different second NCAs are used. For example, and with reference to FIG. 11, tBut-Cys-NCA may be used in combination with Ala-NCA (i.e. two second monomers) with Gal-Thr-NCA (i.e. one first monomer). In the embodiment depicted in FIG. 16, only a single carbohydrate NCA 1604 is shown as the first monomer but more than one first monomer may be used. For example, Gal-Thr-NCA may be used in combination with Glc-Thr-NCA (i.e. two first monomers) with tBut-Cys-NCA may be used in combination with Ala-NCA (i.e. two second monomers).

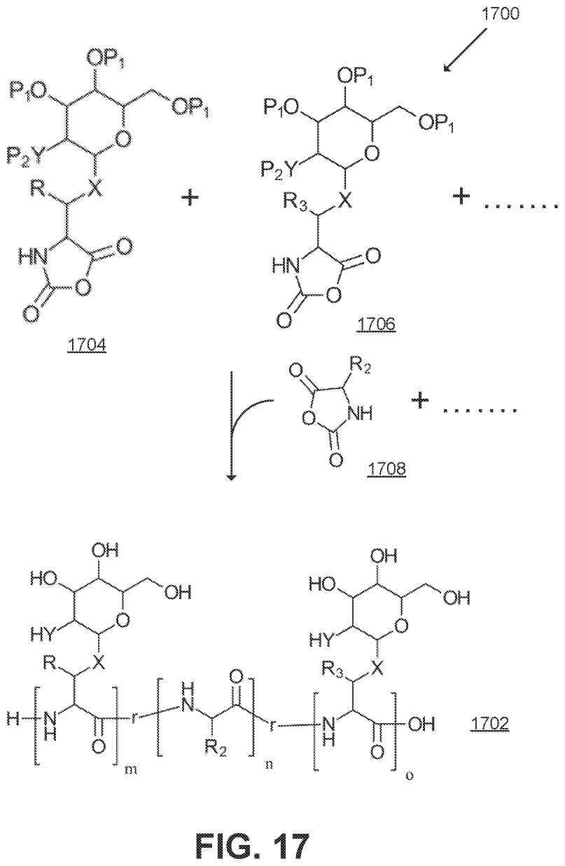

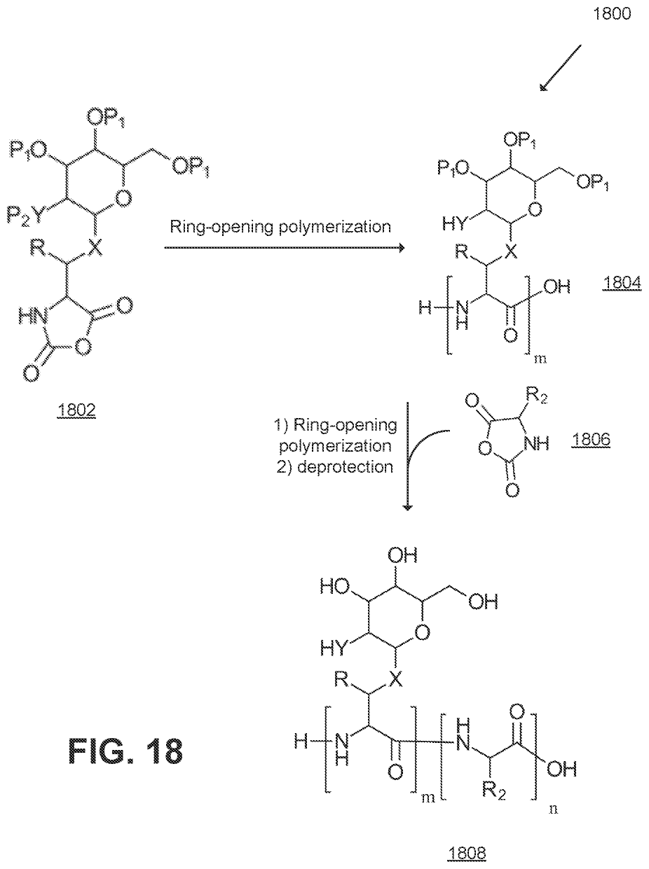

Likewise, FIG. 17 depicts a method 1700 for forming a block-random copolymer 1702. In method 1700, at least two different carbohydrate NCAs 1704, 1706 are copolymerized with at least one second NCA 1708. In one embodiment, two different carbohydrate NCAs are used. In another embodiment, three different carbohydrate NCAs are used. In yet another embodiment, four different carbohydrate NCAs are used. For example, and with reference to FIG. 11, Gal-Thr-NCA may be used in combination with Glc-Thr-NCA (i.e. two first monomers) with tBut-Cys-NCA (i.e. one second monomer). In the embodiment depicted in FIG. 17, only a single NCA 1708 is shown as the second monomer but more than one second monomer may be used. For example, Gal-Thr-NCA may be used in combination with Glc-Thr-NCA (i.e. two first monomers) with tBut-Cys-NCA may be used in combination with Ala-NCA (i.e. two second monomers).

FIG. 18 depicts a method 1800 for forming a (non-random) block copolymer 1800. A carbohydrate NCA 1802 is subjected to ring-opening polymerization to form a homopolymer 1804. Prior to removal of protecting groups P₁ and P₂, the homopolymer 1804 is then mixed with NCA 1806. After deprotection, block-copolymer 1808 is formed.

The disclosed synthetic mucins have been found to interact with collagen such that the collagen is soluble in the mucin. Mixtures of collagen plus the disclosed synthetic mucins are therefore useful with a variety of fields such as drug delivery, the formation of biocompatible scaffolds, cosmetics, skin hydrating compositions, would healing compositions and anti-aging creams.

In the following experiments, a piece of collagen (0.2 mm by 0.2 mm) was cut, placed in 250 microliters of water and sonicated for 30 min. The supernatant was removed and equally distributed in five vials with poly (Gal-Thr)₁₉ at various concentrations (20 wt %, 2 wt %, 0.2 wt % 0.02 wt % and 0 wt %). The final concentrations of mucin (accounting for the water coming from the collagen supernatant) in the five samples was: 11.0 mM, 1.10 mM, 0.11 mM and 0.01 m.

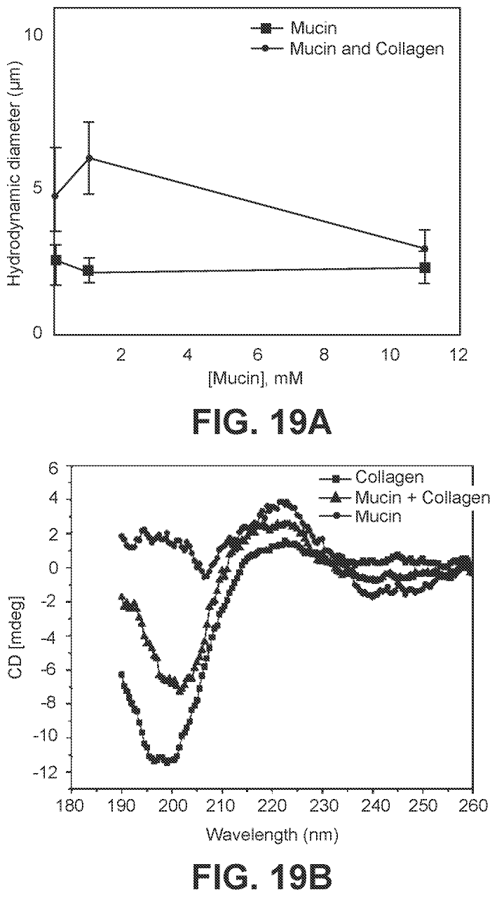

Referring to FIG. 19A, a graph of dynamic light scattering of a synthetic mucin is shown in comparison to that of a mixture of the same synthetic mucin and collagen. The data of FIG. 19A was produced using the poly (Gal-Thr)₁₉. The dynamic light scattering indicated particle size increased as the collagen was incorporated into the synthetic mucin. Similarly, FIG. 19B presents a circular dichroism spectra showing a peak shift as collagen was incorporated in the synthetic mucin sample. The crossover points in FIG. 19B are indicative of a new complex being formed.

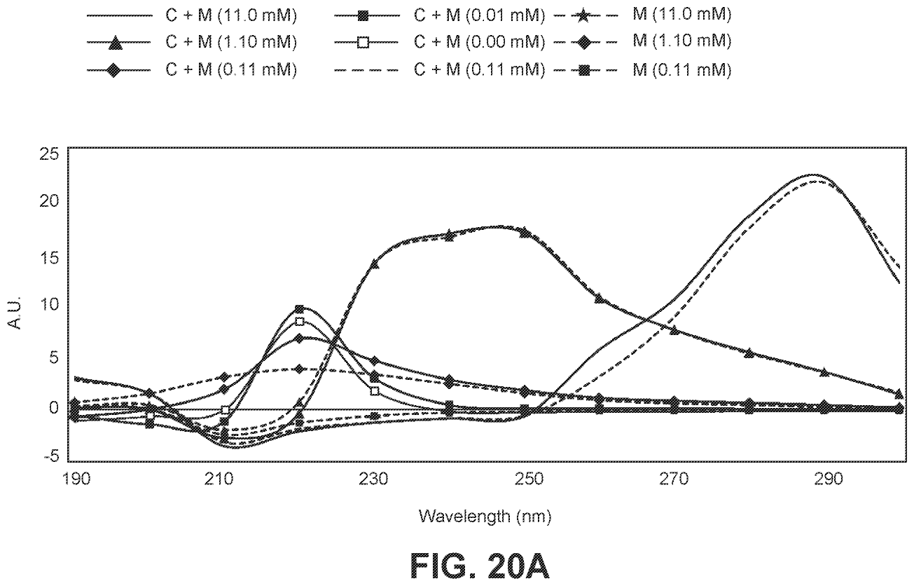

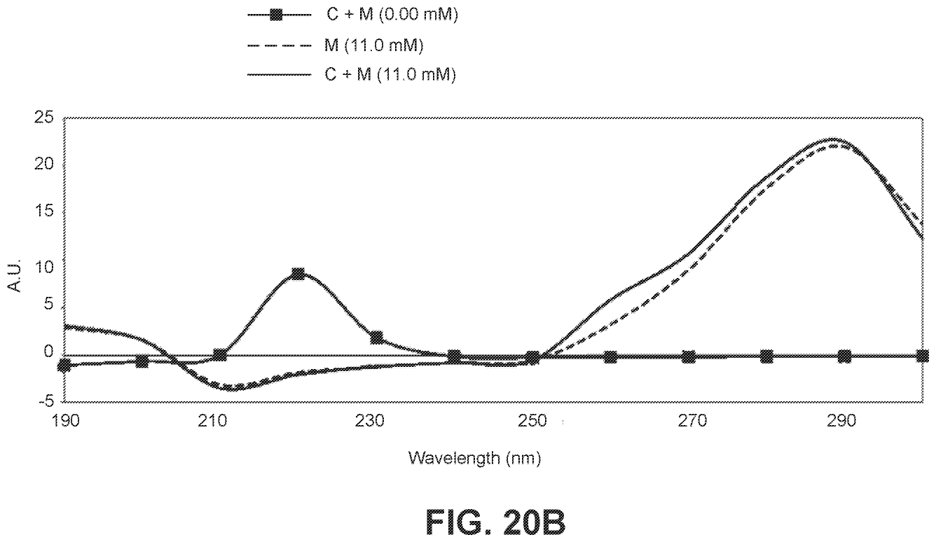

The mixture of the synthetic mucins and collagen have unusual light absorbing characteristics. Referring to FIG. 20A, collagen (alone) absorbs at around 220 nm which the poly (Gal-Thr)₁₉ mucin (alone) absorbs weakly at around 210 nm. Mixtures of the two, however, absorb light at new wavelengths in the range of 220-300 nm (especially at 260 nm). FIG. 20B is similar to FIG. 20A except in that only the data for select runs are presented.

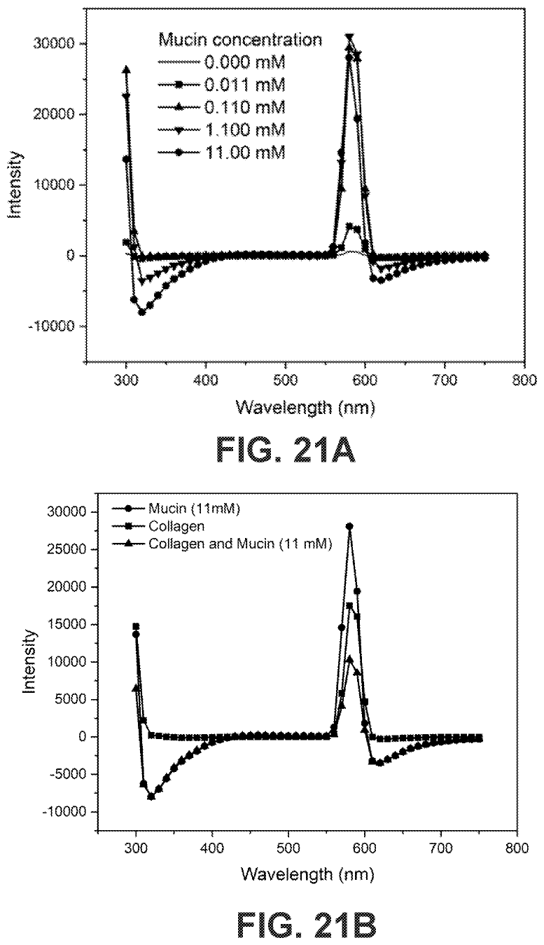

Fluorescence spectroscopy further indicated the mixture of the synthetic mucin and collagen produced a new complex. In FIG. 21A, the poly (Gal-Thr)₁₉ mucin had characteristic bands at 280 nm and 580 nm. As shown in FIG. 21B, collagen alone lacks a band at 280 nm. However, when the mucin and collagen are mixed a band at 280 nm appears.

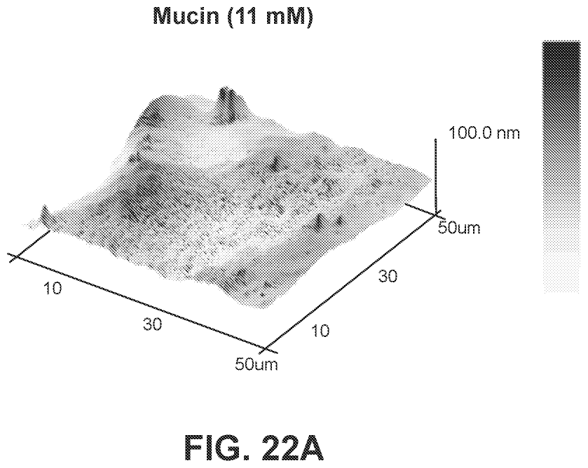

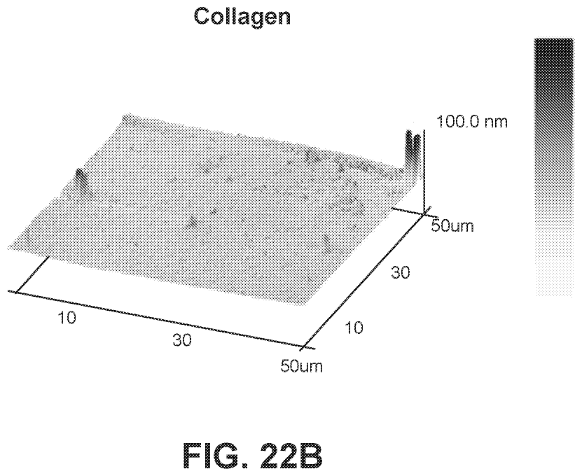

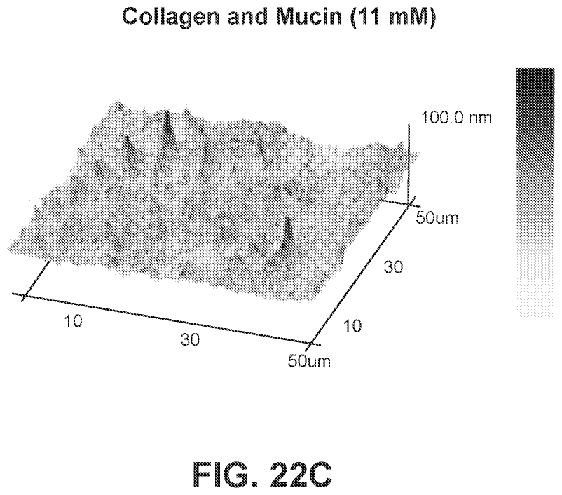

FIG. 22A, FIG. 22B and FIG. 22C depict, respectively, the surface of the poly (Gal-Thr)₁₉ mucin, a collagen, and a hydrogel formed from mixing the mucin and the collagen. The surface morphology was determined by atomic force spectroscopy. For the pure mucin and collagen surface, a relative smooth surface is shown. In contrast, as shown in FIG. 22C, the mixture of collagen and mucin forms a new supramolecular complex as evidenced by the fine surface features that are now apparent.

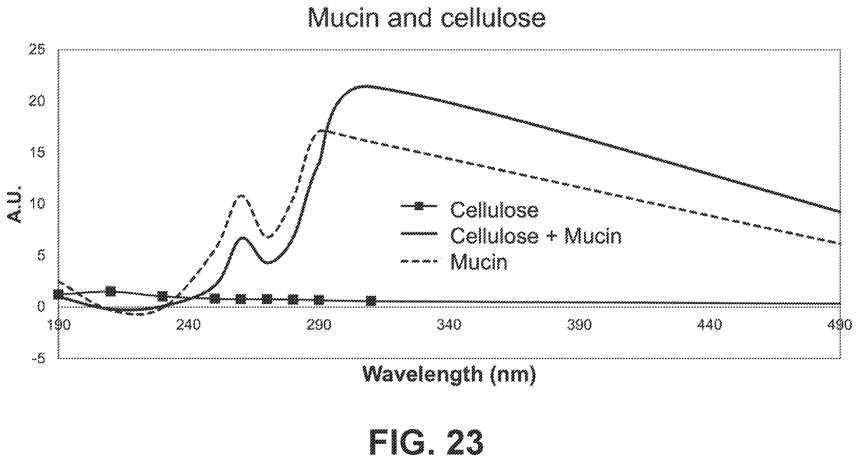

In another embodiment, a mixture of the synthetic mucin and cellulose is provided. An aqueous 20 wt % solution of cellulose (degree of polymerization 221) was made. The supernatant was mixed with an equal volume solution of 20 wt % poly(Gal-Thr)₂₃)-co-Cys)₁ resulting in a final mucin concentration of 10 wt %. FIG. 23 depicts UV-Vis spectra of the cellulose, the mucin, and the cellulose/mucin mixture. The emergence of new absorption peaks indicates a new supramolecular complex is formed.

### Experimental Examples

Example of Procedure for Monomer Synthesis of Step A (Protection of Amino Group). Conversion of compound 500 to compound 502. To a solution of H₂O:THF (60 mL:45 mL), 10 g of L-threonine was dissolved. The mixture was stirred over an ice bath at a setting of approximately −700 rpm while adding sodium bicarbonate (2.2 equivalents—16 g for 10 g of L-threonine) and benzyl chloroformate drop by drop. Then, the reaction was left stirring on ice overnight. After 24 hours of the reaction completion, THF was evaporated and the solution was dissolved in D.I. water and placed in a separatory funnel for extraction. The solution was washed twice with ethyl acetate and the organic layers was discarded while the collective aqueous layer was collected and placed in a new separatory funnel for acid-base extraction. After, a 1:9 HCl:H₂O (50 mL:450 mL) mixture was made and a portion of HCl:H₂O (˜100 mL) was added to the funnel until the solution reached a pH level of 2. The solution was then washed with ethyl acetate. The organic layer was kept and the aqueous layer was washed again two more times to maximize yield. Then the collective organic layers were dried with sodium sulfate. The combined organic layer was then placed to dry on the rotary evaporator and kept sealed. In one embodiment, the hydrogel is formed at a pH less than 6. In another embodiment, the hydrogel is formed at a pH between 6.8 and 7.2

Example of Procedure for Monomer Synthesis of Step B (Protection of Carboxyl Group). Conversion of compound 502 to compound 504. To a solution of Step A, a high vacuum was placed and left for an hour. The mixture was then removed off high vacuum and was dissolved in a 5:1 mixture of MeOH:H₂O (100 mL MeOH and 20 mL water for our batches). After, the solution was placed on an ice bath while being stirred. After completion of the reaction, 0.5 equivalents of cesium carbonate was added to the reaction mixture. The solution was then left in an ice bath for 30 minutes before being removed. Then, the solution was placed on a rotary evaporator to remove methanol. After the removal of methanol, the solution was again placed on a stir plate and left to spin. The combined product was then dissolved in 40 mL (40-50 mL) N,N-dimethyl formamide (DMF). After dissolving, 1.2 equivalents of benzyl bromide were added, drop-by-drop to the system while stirring. The system was capped and left stirring overnight. After 24 hours of the reaction completion, the system was taken off the stir plate and placed over the rotary evaporator (70 C) for 30 minutes to evaporate the DMF. The solution was then extracted using D.I. water and ethyl acetate and was ran twice with both organic layers being combined and kept. After, sodium sulfate was used to dry the product. A TLC plate (2:1 ratio of hexane:EtOAc) was then taken to determine whether the desired product was present. After, the solution was place on a rotary evaporator to remove solvent. Purification was done by column chromatography with a mixture of 3:1 hexane:EtOAc. Once the desired product began to come out, the mixture of solvents was lowered to 2:1 and then added. TLCs was ran using 1:1 of hexane:EtOAc.

Example of Procedure for Monomer Synthesis of Step C (Linkage of Galactose and Threonine). Conversion of compound 504 to compound 508. To a solution of 1-Bromo-2,3,4,6-tetra-O-acetyl-alpha-D-glucopyranoside (0.5 g) dissolved in DCE (20 mL), HgBr₂ (0.4 g) was added. The mixture was heated up until all the solid dissolved (becoming dark brown) with then adding benzyl((benzyloxy)carbonyl)-L-threoninate (0.37 g). The mixture was stirred for 4 hours (6 h in a 10 g scale) at room temperature under Ar (two-neck flask). After, DCE was concentrated under vacuum. Purification was done by column chromatography on the dark brown residue with 2:1 hexane:EtOAc. The obtained product was diluted with ethyl acetate (100 mL), then washed with saturated sodium thiosulfate to remove HgBr₂ (1×). The ethyl acetate layer was kept and the aqueous layer was further extracted with ethyl acetate (3*50 mL). The combined organic layer was dried with Na₂SO₄, filtered, and then evaporated to afford 27.3 mg (45.0%) of 2,3,4,6-tetra-O-acetyl-alpha-D-glycopyranosyl-L-threonine benzyl ester.

Example of Procedure for Monomer Synthesis of Step D (Deprotection of Amine Group). Conversion of compound 508 to compound 510. To a solution of 2,3,4,6-tetra-O-acetyl-alpha-D-glucopyranosyl-L-threonine benzyl ester (1.0 g) dissolved in MeOH, Pd(OH)₂/C (0.1 g, 10% mass of protected Thr) was added. The mixture was stirred for 24 hours at room temperature under Hz atmosphere. After completion of the reaction, the reaction mixture was diluted with MeOH and filtered with 25 mm PTFE to remove Pd(OH)₂/C (all black should be removed). MeOH was then concentrated in a vacuum. The clear residue was crystallized by the addition of ether. Purification was done by crystallization of 2,3,4,6-tetra-O-acetyl-alpha-D-glucopyranosyl-L-threonine in EtOAc\ether (1:1) to afford (0.50 g, 75.0%).

Example of Procedure for Monomer Synthesis of Step E (Cyclopentane Formation). Conversion of compound 510 to compound 512. To a solution of 2,3,4,6-tetra-O-acetyl-alpha-D-glucopyranosyl-L-threonine (0.1 g) dissolved in dry THF (10 mL), alpha-pinene (0.15 mL) followed by triphosgene (0.07 g) was added. The mixture was stirred for 24 hours at room temperature. After completion of the reaction, the reaction mixture evaporated THF, then the residue was dissolved in ethyl acetate and washed in cold water. The organic phase was taken and washed with cold saturated sodium bicarbonate (1×) and cold saturated sodium chloride (1×). The combined organic layer was then dried with sodium sulfate and filtered through celite and the ethyl acetate was evaporated. The residue was dissolved again ethyl acetate and crystalized by the addition of hexane. Purification was done by crystallization of 2,3,4,6-tetra-O-acetyl-alpha-D-glucopyranosyl-L-threonine-NCA in EtOAc\Hexane 1:1 ratio, to afford (0.074 g, 70%).

Example 1 of Procedure for Polymer Synthesis. To a solution of 2,3,4,6-tetra-0-acetyl-alpha-D-glucopyranosyl-L-threonine-NCA in a reflux set up, THF and LiHMDS was added at 70 C temperature. The mixture was left stirring for 8 days.

Example 2 of Procedure for Polymer Synthesis. To a solution of 2,3,4,6-tetra-0-acetyl-alpha-D-glucopyranosyl-L-threonine-NCA on a stirring plate, DCM, HFAB, and LiHMDS was added at room temperature. The mixture was left stirring for 8 days.

Example 3 of Procedure for Polymer Synthesis. To a solution of 2,3,4,6-tetra-0-acetyl-alpha-D-glucopyranosyl-L-threonine-NCA in a reflux set up, THF and Ni was added at room temperature. The mixture was left stirring for 8 days.

Example of Procedure for Deprotection of polymer. To a solution of the polymer, methanol, saturated potassium, mixture of 1:1 polymer and water was added. The mixture was stirred for 48 hours at room temperature. After completion of the reaction, the mixture was passed through dialysis for 3 days. After dialysis, the mixture was frozen under liquid nitrogen and placed in a lyophilizer for about 3 days (should be fully dry).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A composition of matter comprising:
a polymer produced from (1) performing a ring-opening polymerization of a mixture comprising:
a solvent;
a first monomer with a structure of: 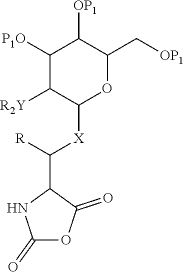
wherein P₁ and P₂ are protecting groups, X is S or O, Y is O or NH and R is selected from a group consisting of H and CH₃;
and then (2) performing a deprotection reaction wherein at least one P₁ is removed.

2. The composition of matter as recited in claim 1, wherein R is CH₃.

3. The composition of matter as recited in claim 1, wherein X is O and Y is O.

4. The composition of matter as recited in claim 1, wherein P₁ and P₂ are identical.

5. The composition of matter as recited in claim 1, wherein P₁ and P₂ are identical and the step of performing the deprotection reaction removes both the at least one P₁ and the P₂.

6. The composition of matter as recited in claim 1, wherein the polymer has a structure of: 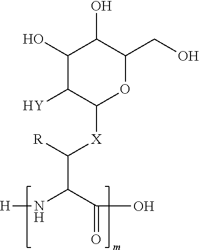
wherein m is an integer that is at least 1 and less than or equal to 150.

7. The composition of matter as recited in claim 6, wherein X is O and Y is O.

8. The composition as recited in claim 1, wherein the polymer has a molecular weight of at least 3 kDa but less than 20 kDa.

9. The composition as recited in claim 1, further comprising a metal ion and water, thereby forming a hydrogel.

10. The composition as recited in claim 1, further comprising an additive selected from a group consisting of collagen and cellulose.

11. The composition of matter as recited in claim 1, wherein the mixture further comprises a second monomer with a structure of: 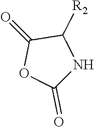
wherein R₂ is selected from a group consisting of CH(CH₃)OH, CH₂OH, CH₃, isobutyl, CH₂SH, benzyl, 4-methoxybenzyl, benzyloxymethyl, 9-fluorenylmethyl-oxycarbonyl, trityl, diphenylmethyl, tetrahydropyranyl, 3,4-dimethylbenzyl, methylbenzyl, 1-adamantyl, 2,4,6-trimethyoxybenzyl, pseudoprolines, 4-methyltrityl, 4-methoxytrityl, 9H-xanthen-9-yl, 4-methyoxybenzyloxymethyl, 2,6-dimethoxybenzyl, 4-methoxy-2-methylbenzyl, acetamidomethyl, 5-dibenzosuberyl, benzamidomethyl, dimethylphosphinothioyl, trimethyl-acetamidomethyl, 9-fluorenylmethyl, phenyl-acteamidomethyl, CH₂SSO₂CH₂CH₃, CH₂SSCH₂(t-butyl), a protected CH₂SH, a protected glucose and a protected galactose and

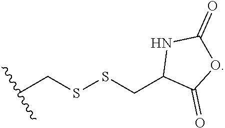 [SMILES: *CSSCC1NC(=O)OC1=O]

12. The composition of matter as recited in claim 11, wherein the polymer has a structure of: 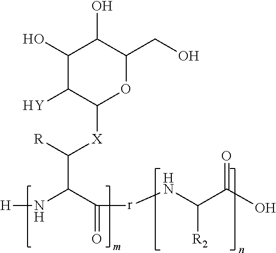
wherein r denotes random copolymerization of the first monomer and the second monomer and m and n are independently selected integers between 1 and 150.

13. The composition of matter as recited in claim 12, wherein R₂ is CH₂SH and the composition further comprises a metal ion and water such that the composition of matter is a hydrogel.

14. The composition of matter as recited in claim 13, wherein X is O and Y is O.

15. The composition of matter as recited in claim 11, wherein X is O, Y is O and R₂ is CH₂SH.

16. A composition of matter comprising a polymer produced from sequentially
(1) performing a ring-opening polymerization of a mixture comprising:
a solvent;
a first monomer with a structure of: 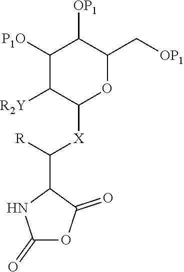
a second monomer with a structure of: 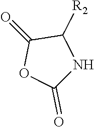
wherein P₁ and P₂ are protecting groups, X is S or O, Y is O or NH and R is selected from a group consisting of H and CH₃ and R₂ is a protected CH₂SH;
(2) performing at least one deprotection reaction wherein at least one P₁ is removed and wherein the protected CH₂SH is deprotected to produce thiols;
(3) oxidizing the thiols to crosslink the polymer, thereby producing a hydrogel.

17. The composition as recited in claim 16, wherein X is O and Y is O.

18. A method for synthesizing a composition of matter, the method comprising sequential steps of:
performing a ring-opening polymerization of a mixture comprising:
a solvent;
a first monomer with a structure of: 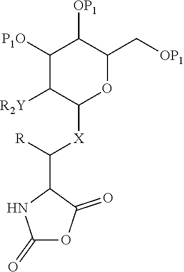
wherein P₁ and P₂ are protecting groups, X is S or O, Y is O or NH and R is selected from a group consisting of H and CH₃;
performing a deprotection reaction wherein at least one P₁ is removed.

19. The method as recited in claim 18, wherein P₁ and P₂ are identical and the step of performing the deprotection reaction removes both the at least one P₁ and the P₂.

20. The method as recited in claim 18, wherein X is O and Y is O.

21. The method as recited in claim 18, wherein the mixture further comprises a second monomer with a structure of: 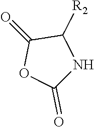
wherein R₂ is selected from a group consisting of CH(CH₃)OH, CH₂OH, CH₃, isobutyl, CH₂SH, CH₂SSO₂CH₂CH₃, CH₂SSCH₂(t-butyl), a protected CH₂SH, a protected glucose and a protected galactose and

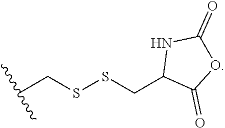 [SMILES: *CSSCC1NC(=O)OC1=O]

22. A composition of matter with a structure of: 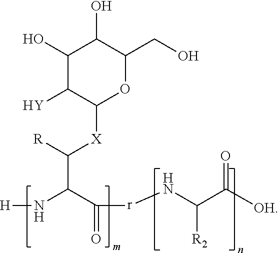
wherein m and n are independently selected integers between 1 and 150, X is S or O, Y is O or NH and R is selected from a group consisting of H and CH₃, and R₂ is selected from a group consisting of CH(CH₃)OH, CH₂OH, CH₃, CH₂SH and isobutyl and r denotes random copolymerization.

23. A composition of matter with a structure of: 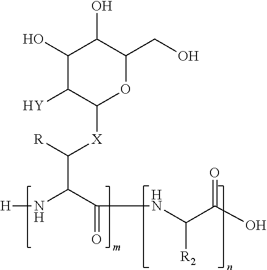
wherein m and n are independently selected integers between 1 and 150, X is S or O, Y is O or NH and R is selected from a group consisting of H and CH₃, and R₂ is selected from a group consisting of CH(CH₃)OH, CH₂OH, CH₃, CH₂SH and isobutyl.
